(19) United States
(12) Patent Application Publication
(10) Pub. No.: US 2025/0042359 A1
(43) Pub. Date: Feb. 6, 2025

(54) VEHICLE AUTHENTICATION SYSTEM

(71) Applicant: Hyundai Kefico Corporation, Gunpo, Gyeonggi-do (KR)

(72) Inventors: Young Sun Cho, Hwaseong, Gyeonggi-do (KR); Sung Dae Jung, Gunpo, Gyeonggi-do (KR); Hyung Jin Kim, Ansan, Gyeonggi-do (KR); Bong Jin Seong, Suwon, Gyeonggi-do (KR); Hyeong Tae Noh, Gunpo, Gyeonggi-do (KR)

(21) Appl. No.: 18/709,251

(22) PCT Filed: Oct. 28, 2022
(86) PCT No.: PCT/KR2022/016702

§ 371 Date: May 10, 2024

(30) Foreign Application Priority Data
Nov. 11, 2021 (KR) 10-2021-0154956

(51) Int. Cl. B60R 25/24; H04L 9/08

(52) U.S. Cl. CPC B60R 25/24; H04L 9/0816; B60R 2325/101; B60R 2325/103; B60R 2325/108; B60R 2325/205

(57) ABSTRACT

A security-enhanced vehicle authentication system enables user authentication only through a device previously registered in a security server. The vehicle authentication system includes: a vehicle controller configured to be installed in a vehicle and to determine whether to allow the vehicle to be driven through user authentication; a user terminal configured to generate authentication data related to the user authentication and to transmit the authentication data to the vehicle controller; and a security server configured to generate a secret key and an encryption key for generating the authentication data. The security server may generate the secret key and the encryption key using unique information of at least any one of the vehicle controller or the user terminal.

### CROSS-REFERENCE TO RELATED APPLICATION(S)

The present application is a U.S. National Phase application under 35 U.S.C. § 371 of International Application No. PCT/KR2022/016702 filed on Oct. 28, 2022, which claims under 35 U.S.C. § 119 (a) the benefit of Korean Application No. 10-2021-0154956 filed on Nov. 11, 2021, the entire contents of which are incorporated by reference herein.

### BACKGROUND

### (a) Technical Field

The present disclosure relates to a vehicle authentication system configured to determine whether to allow a vehicle to be driven, more particularly, to a security-enhanced vehicle authentication system which enables user authentication only through a device previously registered in a security server.

### (b) Description of the Related Art

Recently, as smartphones are widely spreading, various comfort systems using the smartphones are increasing. An example of this is technology that uses a dedicated application installed on a user's smartphone instead of a conventional keyfob previously used as a smart key for a vehicle, thereby performing user authentication for opening the vehicle's door and starting the vehicle, etc., and determining whether to allow the vehicle to be driven.

This technology may also enable various controls over various electronic systems of the vehicle using a dedicated application on the smartphone after user authentication. The user authentication may be performed, for example, when authentication keys stored in the vehicle and in the smartphone are compared with each other and matched.

However, if the authentication key is vulnerable to security, the vehicle is at risk of theft. Therefore, it is desirable to encrypt the authentication key. Only when the encryption can be decrypted only on the user's smartphone, that is, the user's terminal, the most complete security can be maintained. Therefore, there is a requirement for the development of a vehicle authentication system which enables such security.

Meanwhile, in terms of cost, environment, user convenience, etc., it is expected that vehicle ownership is gradually converted into sharing. In this case as well, user authentication must be able to be performed such that a person designated as a sharer is allowed to drive the vehicle. In other words, there is also a requirement for a vehicle authentication system which, as described above, is capable of not only enhancing the security of user authentication but also allowing a vehicle owner to easily authorize the sharer an authority to drive the vehicle.

### SUMMARY

The purpose of the present disclosure is to provide a security-enhanced vehicle authentication system which enables the encryption of a secret key that is used for user authentication to be decrypted only in a user terminal.

Also, the purpose of the present disclosure is to provide a vehicle authentication system capable of not only enhancing the security for user authentication but allowing a vehicle owner to easily authorize a sharer an authority to drive the vehicle.

One embodiment is a vehicle authentication system including: a vehicle controller configured to be installed in a vehicle and to determine whether to allow the vehicle to be driven through user authentication; a user terminal configured to generate authentication data related to the user authentication and to transmit the authentication data to the vehicle controller; and a security server configured to generate a secret key and an encryption key for generating the authentication data. The security server may generate the secret key and the encryption key using unique information of at least any one of the vehicle controller or the user terminal.

The unique information may be a unique ID of a processor built in the vehicle controller or in the user terminal.

When the user authentication is performed, the user terminal and the vehicle controller may be connected through short-range wireless communication.

When the user terminal is connected on-line to enable long-range wireless communication with the security server and the vehicle controller is in an offline state where long-range wireless communication is not possible, the security server may generate the secret key using the unique information of the vehicle controller and may encrypt the secret key, and then may transmit the secret key to the user terminal.

The security server may generate the encryption key for encrypting the secret key by using the unique information of the user terminal.

The user terminal may decrypt the received encrypted secret key using the unique information of the user terminal, may generate random number data, and then may generate the authentication data using the random number data and the secret key, and may transmit the random number data and the authentication data to the vehicle controller.

The vehicle controller may independently generate the secret key using the unique information of the vehicle controller, may generate verification data using the random number data received from the user terminal and the secret key, and may complete the user authentication based on a result of comparison between the authentication data and the verification data.

When both the user terminal and vehicle controller are connected on-line such that they are capable of long-range wireless communication with the security server, the security server may generate the secret key using both the unique information of the vehicle controller and the unique information of the user terminal and may encrypt the secret key, and then may transmit the secret key to the vehicle controller and the user terminal, respectively.

The security server may generate a first encryption key for encrypting the secret key using the unique information of the vehicle controller, and may generate a second encryption key for encrypting the secret key using the unique information of the user terminal.

The security server may transmit the secret key encrypted with the first encryption key to the vehicle controller, and may transmit the secret key encrypted with the second encryption key to the user terminal.

The user terminal may decrypt the received encrypted secret key using the unique information of the user terminal related to the second encryption key, may generate random number data, and then may generate the authentication data using the random number data and the secret key, and may transmit the random number data and the authentication data to the vehicle controller.

The vehicle controller may decrypt the received encrypted secret key using the unique information of the vehicle controller related to the first encryption key, may generate verification data using the random number data received from the user terminal and the secret key, and may complete the user authentication based on a result of comparison between the authentication data and the verification data.

The vehicle authentication system may further include an owner terminal which is carried by an owner of the vehicle and shares an authority to drive the vehicle with the user terminal.

Here, the owner terminal may transmit a shared password to the user terminal and the security server.

Here, user terminal may perform sharer authentication by transmitting the unique information of the user terminal and the shared password to the security server, and then may proceed with the user authentication.

According to the embodiment of the present disclosure, the encryption key for encrypting the secret key is generated using the unique information of the user terminal, so that the decryption of the secret key is possible only in the user terminal, and thus security can be further enhanced.

Also, according to the embodiment, the shared password is transmitted to the vehicle owner's terminal and the terminal of the sharer who shares the vehicle, and the sharer who receives the shared password first performs the sharer authentication using the shared password and then secondly performs the encrypted user authentication using the unique information of the sharer terminal. Accordingly, the security for the user authentication is enhanced, and simultaneously with this, the vehicle owner can easily authorize the sharer an authority to drive the vehicle.

Further scope of applicability of the present disclosure will become apparent from the following detailed description for embodying the present disclosure. However, since various changes and modifications within the spirit and scope of the present disclosure can be clearly understood by those skilled in the art, specific embodiments such as embodiments included in the following detailed description for embodying the present disclosure should be understood as being merely illustrative.

### BRIEF DESCRIPTION OF THE DRAWINGS

FIG. 1 is a conceptual view of a vehicle authentication system according to an embodiment of the present disclosure;

FIG. 2 shows generation, encryption, and transmission process of a secret key in the vehicle authentication system of FIG. 1;

FIG. 3 shows a user authentication process between the vehicle and a user terminal in the vehicle authentication system of FIG. 1;

FIG. 4 is a flowchart showing the entire user authentication process in the vehicle authentication system of FIG. 1;

FIG. 5 is a conceptual view of a vehicle authentication system according to another embodiment of the present disclosure;

FIG. 6 shows secret key generation, encryption, and transmission process in the vehicle authentication system of FIG. 5;

FIG. 7 is a flowchart showing the entire user authentication process in the vehicle authentication system of FIG. 5;

FIG. 8 is a conceptual view of a vehicle authentication system according to further another embodiment of the present disclosure; and

FIG. 9 is a flowchart showing a process of sharer authentication prior to user authentication.

### DETAILED DESCRIPTION

Hereinafter, an embodiment of the present disclosure will be described in detail with reference to the accompanying drawings.

As the present disclosure can have various embodiments as well as can be diversely changed, specific embodiments will be illustrated in the drawings and described in detail. While the present disclosure is not limited to particular embodiments, all modification, equivalents and substitutes included in the spirit and scope of the present disclosure are understood to be included therein.

In the description of the present disclosure, while terms such as the first and the second, etc., can be used to describe various components, the components may not be limited by the terms mentioned above. The terms are used only for distinguishing between one component and other components. For example, the first component may be designated as the second component without departing from the scope of rights of the disclosure. Similarly, the second component may be designated as the first component.

The term of “and/or” includes a combination or one of a plurality of related items mentioned.

In the case where a component is referred to as being “connected” or “accessed” to another component, it should be understood that not only the component is directly connected or accessed to the other component, but also there may exist another component between them. Meanwhile, in the case where a component is referred to as being “directly connected” or “directly accessed” to another component, it should be understood that there is no component therebetween.

Terms used in the present specification are provided for description of only specific embodiments of the present disclosure, and not intended to be limiting. An expression of a singular form includes the expression of plural form thereof unless otherwise explicitly mentioned in the context.

In the present specification, it should be understood that the term “include” or “comprise” and the like is intended to specify characteristics, numbers, steps, operations, components, parts or any combination thereof which are mentioned in the specification, and intended not to previously exclude the possibility of existence or addition of at least one another characteristics.

Unless otherwise defined, all terms used herein including technical and scientific terms have the same meaning as commonly understood by one of ordinary skill in the art to which the present disclosure belongs. Terms, for example, commonly used terms defined in the dictionary, are to be construed to have exactly the same meaning as that of related technology in the context. As long as terms are not clearly defined in the present application, the terms should not be ideally or excessively construed as formal meaning.

Also, the embodiment is provided for giving those skilled in the art more complete description. Therefore, the shapes and sizes and the like of components of the drawings may be exaggerated for clarity of the description.

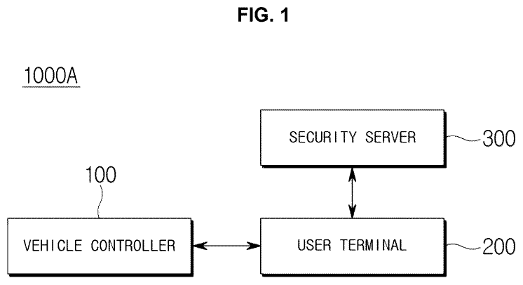

FIG. 1 is a conceptual view of a vehicle authentication system according to an embodiment of the present disclosure.

Referring to FIG. 1, a vehicle authentication system 1000A according to the embodiment of the present disclosure may include a vehicle controller 100, a user terminal 200, and a security server 300.

The vehicle controller 100 is installed in a vehicle and may determine whether to allow the vehicle to be driven through user authentication. More specifically, the vehicle controller 100 is a device that is mounted within the vehicle and controls the operation of the vehicle. The vehicle controller 100 may be a common electronic control device commonly designated as an electronic control unit (ECU). The vehicle controller 100 may be referred to as a vehicle control unit (VCU).

The vehicle controller 100 may include a processor. The processor may be any of various controllers that can perform operations by executing computer program instructions, such as CPU, MCU, microcontroller, microprocessor, etc.

Decryption of a secret key and generation of verification data, which will be described later, may be performed by the processor.

The vehicle controller 100 may include its own unique information. The unique information of the vehicle controller 100 is unique to the vehicle controller and can be distinguished from a vehicle controller mounted on another vehicle. The unique information may be, for example, a unique ID of a processor built in the vehicle controller 100.

The vehicle controller 100 may be equipped with a communication module which enables short-range wireless communication with the user terminal 200. For example, various communication methods such as Bluetooth communication, near field communication (NFC), etc., can be applied to the short-range wireless communication. However, the short-range wireless communication is not limited thereto. Various widely known wireless communication or mobile communication methods can be applied.

The vehicle controller 100 may be equipped with a communication module which enables long-range wireless communication with the security server 300. For example, various communication methods such as wireless LAN (WLAN), digital living network alliance (DLNA), wireless broadband (Wibro), world interoperability for microwave access (Wimax), global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), IEEE 802.16, long term evolution (LTE), long term evolution-advanced (LTEA), wireless mobile broadband service (WMBS), bluetooth low energy (BLE), Zigbee, radio frequency (RF), long range (LoRa), etc., can be applied. However, the long-range wireless communication is not limited thereto. Various widely known wireless communication or mobile communication methods can be applied.

The user terminal 200 may refer to a device carried by a user who attempts user authentication in order to drive a vehicle. More specifically, a dedicated application for performing the user authentication is installed on the user terminal 200. For example, user terminal 200 may be an electronic device such as a smartphone, a tablet PC, or a wearable device, etc.

The user terminal 200 may be equipped with a communication module which enables short-range wireless communication with the vehicle controller 100.

The user terminal 200 may be equipped with a communication module which enables long-range wireless communication with the security server 300.

Like the vehicle controller 100, the user terminal 200 may also include a processor. The processor 100 may be any of various controllers that can perform operations by executing computer program instructions, such as CPU, MCU, microcontroller, microprocessor, etc.

Decryption of the secret key and generation of authentication data, which will be described later, may be performed by the processor.

The user terminal 200 may include its own unique information. The unique information of the user terminal 200 is unique to the user terminal and can be distinguished from another terminal. The unique information may be, for example, a unique ID of a processor built in the user terminal 200.

The user terminal 200 may generate authentication data related to the user authentication and transmit it to the vehicle controller 100. More specifically, when the authentication data generated by the user terminal 200 is transmitted to the vehicle controller 100, the vehicle controller 100 may compare the authentication data with the verification data generated by the user terminal 200 itself and may determine whether to allow the vehicle to be driven. The user authentication is a result of the determination. The success of the user authentication means that the user is permitted to drive the vehicle, and the failure of the user authentication means that the user is not permitted to drive the vehicle. The permission can be realized by opening the door, turning on the engine, etc.

The generation process of the authentication data and verification data will be described later.

The security server 300 may generate a secret key and an encryption key used by the user terminal 200 to generate the authentication data. The security server 300 may transmit data to the vehicle controller 100 and/or the user terminal 200 through long-range wireless communication. The data may represent a secret key encrypted using the encryption key generated by the security server 300.

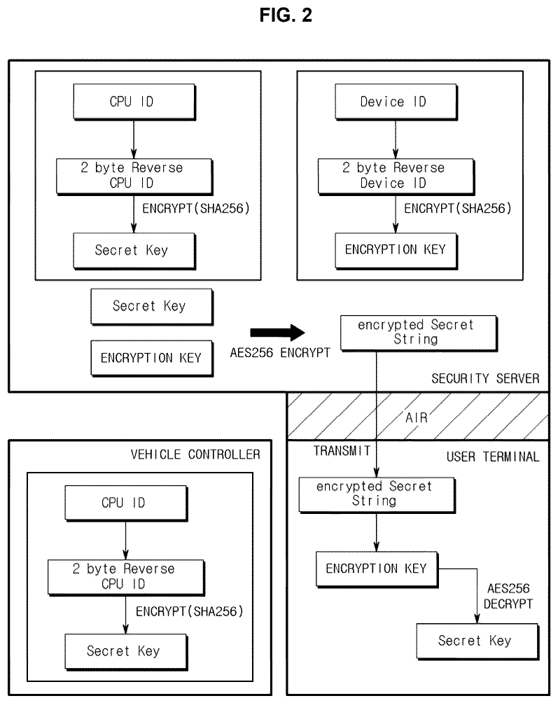

Hereinafter, in the embodiment of FIG. 1, a user authentication process of the vehicle authentication system will be described in detail with further reference to FIGS. 2, 3, and 4.

The embodiment of FIG. 1 shows a case in which the vehicle controller 100 is offline, that is, the security server 300 is not able to communicate with the vehicle controller 100 and is able to communicate with only the user terminal 200.

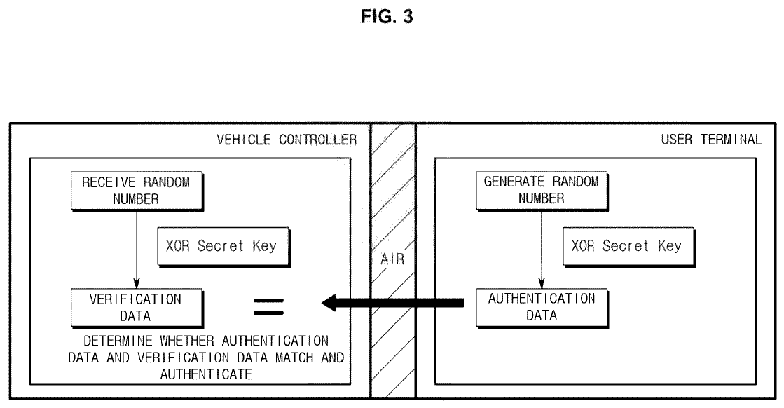

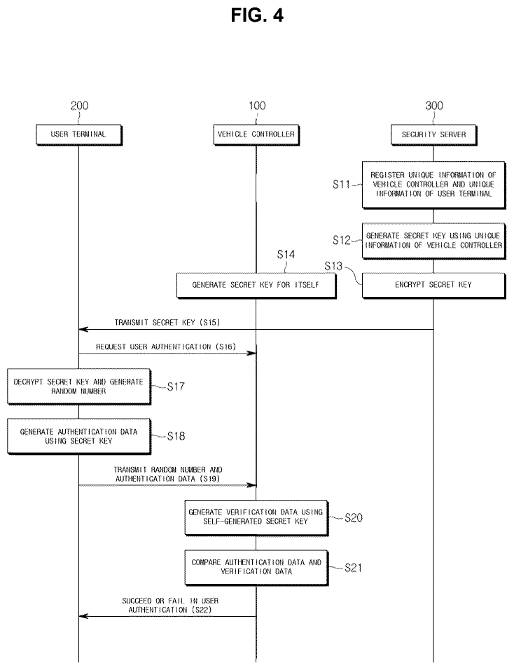

FIG. 2 shows generation, encryption, and transmission process of a secret key in the vehicle authentication system of FIG. 1. FIG. 3 shows a user authentication process between the vehicle and the user terminal in the vehicle authentication system of FIG. 1. FIG. 4 is a flowchart showing the entire user authentication process in the vehicle authentication system of FIG. 1.

Referring to FIG. 2, the user terminal 200 is connected on-line to enable long-range wireless communication with the security server 300, and the vehicle controller 100 is in an offline state where long-range wireless communication is not possible. In the present specification, online and offline may be used as terms indicating whether a device (vehicle controller or user terminal) is connected to a network for long-range wireless communication. In other words, a state where the device is connected to the network is online, and a state where not connected to the network is offline.

In the security server 300, unique information (CPU ID) of the vehicle controller 100 and unique information (Device ID) of the user terminal 200 are registered in advance (S11).

The security server 300 generates a secret key using the unique information (CPU ID) of the vehicle controller 100 (S12). As an example, SHA256 algorithm may be used to generate the secret key. The SHA256 algorithm is a hash algorithm that creates a message of arbitrary length into an abbreviated message of 256 bits and has a one-way encryption method.

The security server 300 generates the encryption key using the unique information (Device ID) of the user terminal 200 and encrypts the secret key using the encryption key (S13). As an example, the SHA256 algorithm may be used to generate the encryption key. Also, the AES256 algorithm can be used in the process of encrypting the secret key by the encryption key. The AES256 algorithm enables the authentication when two devices attempting to perform the authentication share the same key.

Since the security server 300 generates the encryption key using the unique information of the user terminal 200, only the user terminal 200 shares the encryption key with the security server 300. That is, since only the user terminal 200 can decrypt the secret key and other devices cannot decrypt the secret key, security for user authentication can be further enhanced.

In other words, even if leakage occurs during the transmission of the encrypted secret key, no secret key can be obtained by decryption because nothing but the user terminal 200 has the encryption key.

Also, the encryption key itself is also generated through the SHA256 hashing algorithm. If the unique information of the user terminal 200 is even slightly inconsistent, the encryption key is generated completely differently, so that replication of the encryption key is impossible, which doubles the effect of enhancing security.

Meanwhile, the vehicle controller 100 independently generates the secret key using the unique information of the vehicle controller 100 for itself (S14). When the vehicle controller 100 generates the secret key for itself, the vehicle controller 100 uses the same input value and the same algorithm as an encryption algorithm used when the security server 300 generates the secret key.

That is, when the security server 300 uses the unique information of the vehicle controller 100 as an input value and generates the secret key using the SHA256 algorithm, the vehicle controller 100 must also use the unique information of the vehicle controller 100 as an input value and generate the secret key using the SHA256 algorithm, in the same way as the security server 300.

When the SHA256 algorithm is performed, the “same string” always outputs the same digest. Therefore, even in an offline state where the vehicle controller 100 is not connected to the security server 300 by communication, the vehicle controller 100 is able to generate the same secret key for itself using the unique information of the vehicle controller.

That is, in the present disclosure, even when one of two devices performing the user authentication is offline, the unique information of the offline device is used to generate the secret key, so that there is an advantage of performing the security-enhanced user authentication even through communication between the other online device and the security server 300.

The security server 300 transmits the encrypted secret key to the user terminal 200 through wireless communication (S15). As described above, since the vehicle controller 100 independently generates the secret key for itself, it is not necessary to transmit the encrypted secret key to the vehicle controller 100.

The user terminal 200 may request the user authentication from the vehicle controller 100 in order to perform the user authentication (S16). Here, as described above, the user terminal 200 and the vehicle controller 100 can be connected through short-range wireless communication.

The user terminal 200 decrypts the received encrypted secret key using the unique information of the user terminal 200 and generates random number data (S17). More specifically, the user terminal 200 may generate the encryption key through the same algorithm (SHA256) as that of the security server 300 by using its own unique information and then may use the encryption key for decryption (see FIG. 2).

Then, the user terminal 200 generates the authentication data for the user authentication using the random number data and the secret key (S18).

The user terminal 200 transmits the generated random number data and authentication data to the vehicle controller 100 (S19).

Meanwhile, the vehicle controller 100 that has generated the secret key for itself generates verification data using the random number data received from the user terminal 200 and the secret key that the vehicle controller 100 itself has generated (S20). Then, the vehicle controller 100 compares the authentication data transmitted by the user terminal 200 with the generated verification data (S21). The vehicle controller 100 can complete the user authentication by determining whether the authentication data and the verification data match. More specifically, if the authentication data and the verification data match, the user authentication is determined to be successful, and if they do not match, the user authentication is determined to have failed (S22) (see FIG. 3).

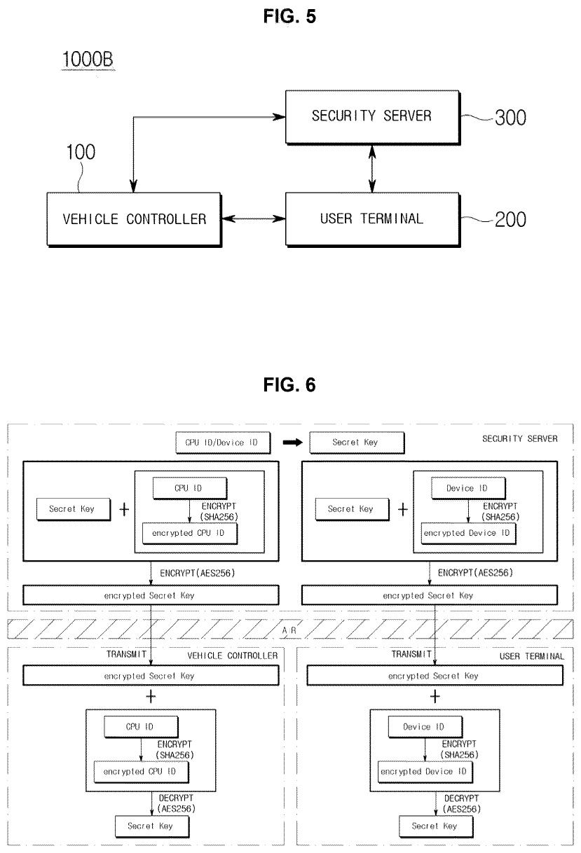

FIG. 5 is a conceptual view of the vehicle authentication system according to another embodiment of the present disclosure,

While an embodiment 1000B of FIG. 5 includes the user terminal 200, vehicle controller 100, and security server 300 which are the same components as those described above, both the user terminal 200 and vehicle controller 100 are online, that is, these components are capable of long-range wireless communication with the security server 300.

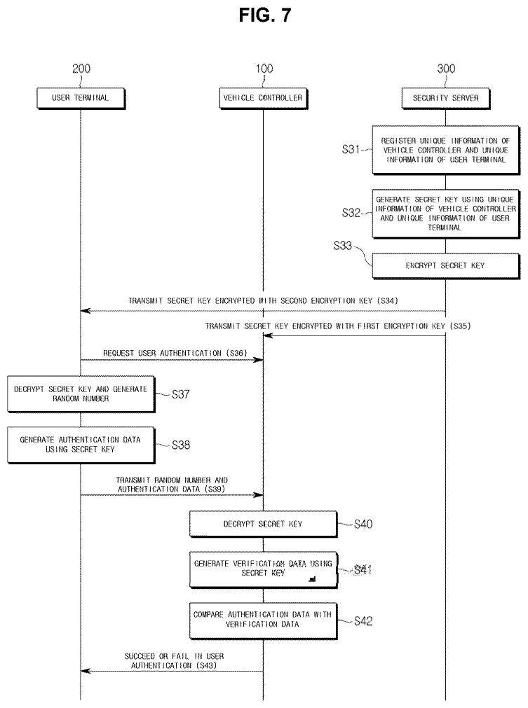

Hereinafter, the user authentication process of the vehicle authentication system will be described in detail with respect to the embodiment of FIG. 5 with further reference to FIGS. 6 and 7.

FIG. 6 shows secret key generation, encryption, and transmission process in the vehicle authentication system of FIG. 5. FIG. 7 is a flowchart showing the entire user authentication process in the vehicle authentication system of FIG. 5.

The unique information (CPU ID) of the vehicle controller 100 and the unique information (Device ID) of the user terminal 200 are registered in advance in the security server 300 in the same manner as the above-described embodiment 1000A (S31).

In the embodiment 1000B, the security server 300 may generate a secret key using both the unique information of the vehicle controller 100 and the unique information of the user terminal 200 (S32). More specifically, the security server 300 may generate a secret key using both the unique information of the vehicle controller 100 and the unique information of the user terminal 200 as input values. For example, MD5 algorithm may be used to generate the secret key. The MD5 is a 128-bit cryptographic hash function that generates a hash value of 128 bits (16 bytes) for message blocks of 512 bits (S32).

The thus generated secret key goes through an encryption process before being transmitted to the vehicle controller 100 and the user terminal 200.

More specifically, the security server 300 may generate a first encryption key for encrypting the secret key using the unique information (CPU ID) of the vehicle controller 100. Simultaneously with this or sequentially, the security server 300 may generate a second encryption key for encrypting the secret key using the unique information (Device ID) of the user terminal 200 (S33). As an example, the SHA256 algorithm may be used to generate the first encryption key and the second encryption key, respectively.

The secret key encrypted with the first encryption key is transmitted to the vehicle controller 100, and the secret key encrypted with the second encryption key is transmitted to the user terminal 200 (S34 and S35).

Here, the first encryption key generated with the unique information of the vehicle controller 100 can be generated only in the vehicle controller 100 in the same manner, and the second encryption key generated with the unique information of the user terminal 200 can be generated only in the vehicle controller 100 in the same manner. Therefore, security for the secret key can be further enhanced.

The user terminal 200 may request the user authentication from the vehicle controller 100 in order to perform the user authentication (S36). Here, as described above, the user terminal 200 and the vehicle controller 100 can be connected through short-range wireless communication.

The user terminal 200 decrypts the received encrypted secret key using the unique information of the user terminal 200 related to the second encryption key and generates random number data (S37). More specifically, the user terminal 200 may generate the second encryption key through the same algorithm (SHA256) as that of the security server 300 by using its own unique information and then may use the second encryption key for decryption (see FIG. 6).

Then, the user terminal 200 generates the authentication data for the user authentication using the random number data and the secret key (S38).

The user terminal 200 transmits the generated random number data and the authentication data to the vehicle controller 100 (S39).

Meanwhile, the vehicle controller 100 performs, by using the unique information of the vehicle controller 100 related to the first encryption key, decryption on the encrypted secret key received (S40), and generates verification data using the random number data received from the user terminal 200 and the secret key received from the security server 300 (S41).

Then, the vehicle controller 100 compares the authentication data transmitted by the user terminal 200 with the verification data generated by the vehicle controller 100 itself (S42). The vehicle controller 100 can complete the user authentication by determining whether the authentication data and the verification data match. More specifically, if the authentication data and the verification data match, the user authentication is determined to be successful, and if they do not match, the user authentication is determined to have failed (S43). In also the embodiment 1000B, FIG. 3 may be referred to the comparison of the authentication data and the verification data.

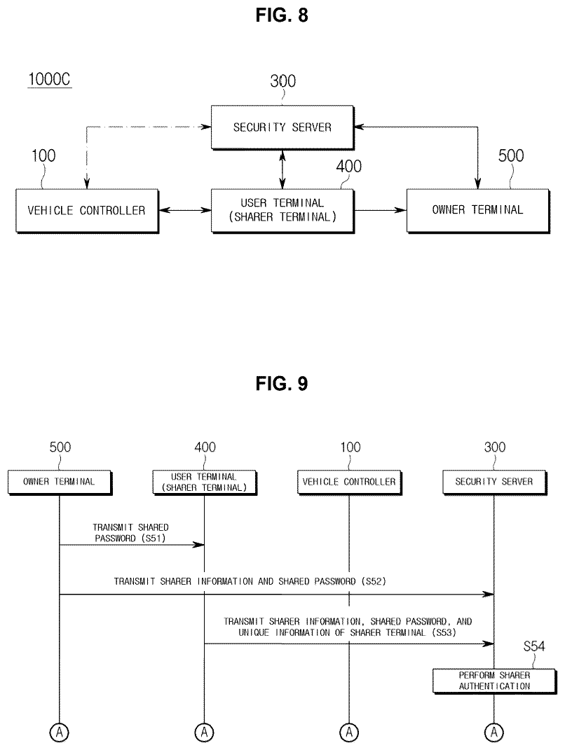

FIG. 8 is a conceptual view of a vehicle authentication system according to further another embodiment of the present disclosure. FIG. 9 is a flowchart showing a process of sharer authentication prior to user authentication.

FIG. 8 shows an embodiment showing a case where a vehicle is shared. A vehicle authentication system 1000C according to the embodiment may further include an owner terminal 500 as a component in addition to the components included in the embodiment of FIG. 1 or FIG. 5.

The owner terminal 500 is carried by an owner of a vehicle and shares an authority to drive the vehicle with the user terminal 400.

Here, the user terminal 200 that is a subject of the user authentication in the embodiments of FIGS. 1 and 5 may be defined as a sharer's terminal 400 (hereinafter, referred to as “sharer terminal”) which shares or takes over temporarily the authority to drive the vehicle from the owner of the vehicle.

The owner terminal 500 may transmit a shared password to the sharer terminal 400 and the security server 300, respectively. Sharer information may be further transmitted together with the shared password to the security server 300. Here, the sharer information can verify a sharer who shares the vehicle. For example, a cell phone number of the sharer, etc., may be included in the sharer information.

The sharer terminal 400 may transmit, to the security server, unique information of the sharer terminal 400 and the shared password received from the owner terminal 500 (S53). Here, the sharer information and the unique information of the sharer terminal 400 may be transmitted together.

The security server 300 may perform sharer authentication by comparing the sharer information received from the owner terminal 500 with the sharer information received from the sharer terminal 400. Also, the security server 300 may perform the sharer authentication by comparing the shared password received from the owner terminal 500 with the shared password received from the sharer terminal.

When the pieces of sharer information (e.g., cell phone number) received from the two terminals 400 and 500 and/or the shared passwords received from the two terminals 400 and 500 do not match, the security server 300 may determine that the sharer authentication has failed. Here, the sharer terminal 400 is no longer able to proceed with the user authentication related to permission to drive the vehicle.

If the sharer authentication is successful as a first authentication for the sharer terminal 400, user authentication related to permission to drive the vehicle is performed as a second authentication. Since the sharer terminal 400 has transmitted its unique information to the security server 300, the security server 300 can generate a secret key using the unique information of the sharer terminal 400.

Here, since the embodiments of FIGS. 1 and 5 can be applied as they are to specific methods and processes by which the user authentication is performed, the specific methods and processes can be replaced with what has been described in the embodiments of FIGS. 1 and 5. That is, the steps shown in FIGS. 4 and 7 may be performed from the sequence connected after “A” in the flowchart of FIG. 9.

As described above, according to the embodiment, the encryption key for encrypting the secret key is generated using the unique information of the user terminal, so that the decryption of the secret key is possible only in the user terminal, and thus security can be further enhanced.

Also, according to the embodiment, the shared password is transmitted to the vehicle owner's terminal and the terminal of the sharer who shares the vehicle, and the sharer who receives the shared password first performs the sharer authentication using the shared password and then secondly performs the encrypted user authentication using the unique information of the sharer terminal. Accordingly, the security for the user authentication is enhanced, and simultaneously with this, the vehicle owner can easily authorize the sharer an authority to drive the vehicle.

Meanwhile, although the present disclosure has been described with the confined embodiment and drawings, the present disclosure is not limited to the embodiment and various changes and modifications can be made from this disclosure by a skilled person in the art. Therefore, the spirit of the present disclosure is understood only by the claims, and any variations equivalent thereto are included in the spirit of the present disclosure.

What is claimed is:

1. A vehicle authentication system comprising:
a vehicle controller configured to be installed in a vehicle and to determine whether to allow the vehicle to be driven through user authentication;
a user terminal configured to generate authentication data related to the user authentication and to transmit the authentication data to the vehicle controller; and
a security server configured to generate a secret key and an encryption key for generating the authentication data,
wherein the security server generates the secret key and the encryption key using unique information of at least any one of the vehicle controller or the user terminal.

2. The vehicle authentication system of claim 1, wherein the unique information is a unique ID of a processor built in the vehicle controller or in the user terminal.

3. The vehicle authentication system of claim 1, wherein, when the user authentication is performed, the user terminal and the vehicle controller are connected through short-range wireless communication.

4. The vehicle authentication system of claim 1, wherein, when the user terminal is connected on-line to enable long-range wireless communication with the security server and the vehicle controller is in an offline state where long-range wireless communication is not possible, the security server generates the secret key using the unique information of the vehicle controller and encrypts the secret key, and then transmits the secret key to the user terminal.

5. The vehicle authentication system of claim 4, wherein the security server generates the encryption key for encrypting the secret key by using the unique information of the user terminal.

6. The vehicle authentication system of claim 5, wherein the user terminal:
decrypts the received encrypted secret key using the unique information of the user terminal,
generates random number data, and then generates the authentication data using the random number data and the secret key, and
transmits the random number data and the authentication data to the vehicle controller.

7. The vehicle authentication system of claim 6, wherein the vehicle controller:
independently generates the secret key using the unique information of the vehicle controller,
generates verification data using the random number data received from the user terminal and the secret key, and
completes the user authentication based on a result of comparison between the authentication data and the verification data.

8. The vehicle authentication system of claim 1, wherein, when both the user terminal and vehicle controller are connected on-line such that they are capable of long-range wireless communication with the security server, the security server generates the secret key using both the unique information of the vehicle controller and the unique information of the user terminal and encrypts the secret key, and then transmits the secret key to the vehicle controller and the user terminal, respectively.

9. The vehicle authentication system of claim 8, wherein the security server:
generates a first encryption key for encrypting the secret key using the unique information of the vehicle controller, and
generates a second encryption key for encrypting the secret key using the unique information of the user terminal.

10. The vehicle authentication system of claim 9, wherein the security server:
transmits the secret key encrypted with the first encryption key to the vehicle controller, and
transmits the secret key encrypted with the second encryption key to the user terminal.

11. The vehicle authentication system of claim 10, wherein the user terminal:
decrypts the received encrypted secret key using the unique information of the user terminal related to the second encryption key,
generates random number data, and then generates the authentication data using the random number data and the secret key, and
transmits the random number data and the authentication data to the vehicle controller.

12. The vehicle authentication system of claim 11, wherein the vehicle controller:
decrypts the received encrypted secret key using the unique information of the vehicle controller related to the first encryption key,
generates verification data using the random number data received from the user terminal and the secret key, and
completes the user authentication based on a result of comparison between the authentication data and the verification data.

13. The vehicle authentication system of claim 1, further comprising an owner terminal which is carried by an owner of the vehicle and shares an authority to drive the vehicle with the user terminal,
wherein the owner terminal transmits a shared password to the user terminal and the security server.

14. The vehicle authentication system of claim 13, wherein the user terminal performs sharer authentication by transmitting the unique information of the user terminal and the shared password to the security server, and then proceeds with the user authentication.
